(19) United States
(12) Patent Application Publication
(10) Pub. No.: US 2008/0138648 A1
(43) Pub. Date: Jun. 12, 2008

(54) Layer system with blocking layer, and production process

(75) Inventors: Knut Halberstadt, Mulheim an der Ruhr (DE); Werner Stamm, Mulheim an der Ruhr (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Aktiengesellschaft

(21) Appl. No.: 11/330,576

(22) Filed: Jan. 12, 2006

(30) Foreign Application Priority Data
Jan. 14, 2005 (EP) 05000730.1

(51) Int. Cl. B32B 15/00

(52) U.S. Cl. 428/678

(57) ABSTRACT

Components according to the prior art, to protect against corrosion, have a protective layer, a metal element (for example Al) of this protective layer forming a protective oxide layer. However, this metal element also diffuses into the substrate in an undesired way. The layer system according to the invention includes a metallic blocking layer which prevents this diffusion, the blocking layer including at least one phase of the PdAl₂, Ta₂Al, NbAl₂ or Nb₃Al type.

### CROSS REFERENCE TO RELATED APPLICATION

This application claims priority of the European application No. 05000730.1 EP filed Jan. 14, 2005, which is incorporated by reference herein in its entirety.

### FIELD OF THE INVENTION

The invention relates to a layer system having a blocking layer as described in the claims and to production processes as claimed.

### BACKGROUND OF THE INVENTION

Components for applications at high temperatures, in particular in turbines, have layers which protect against corrosion of the MCrAlX type, in which the aluminum of the MCrAlX alloy forms a protective oxide layer on the surface of the protective layer. However, the aluminum from this protective layer also diffuses into the base material. However, this is undesirable, and consequently it is an object of the invention to overcome this problem.

U.S. Pat. No. 4,477,538, JP 11 12 46 88A, U.S. Pat. No. 5,427,866, DE 198 42 417 have metallic layers of platinum or palladium which are present between the substrate and protective layer or outer layer.

### SUMMARY OF THE INVENTION

The object is achieved by the layer system and processes as claimed in the claims.

The layer system produced in this way provides improved protection against corrosion, since the aluminum diffuses into the base material to a lesser extent or scarcely does so at all and consequently the depletion of aluminum in the layer which protects against corrosion is reduced in time compared to the prior art. Also, fewer elements diffuse out of the base material into the layer which protects against corrosion. This is made possible by an improved action of the blocking layer as a diffusion barrier.

The subclaims give further advantageous measures for improving the layer system.

### BRIEF DESCRIPTION OF THE DRAWINGS

The measures listed in the subclaims can advantageously be combined with one another as desired. In the drawing:

FIG. 1 shows a layer system according to the invention,

FIG. 2 shows a turbine blade or vane,

FIG. 3 shows a combustion chamber,

FIG. 4 shows a gas turbine.

### DETAILED DESCRIPTION OF THE INVENTION

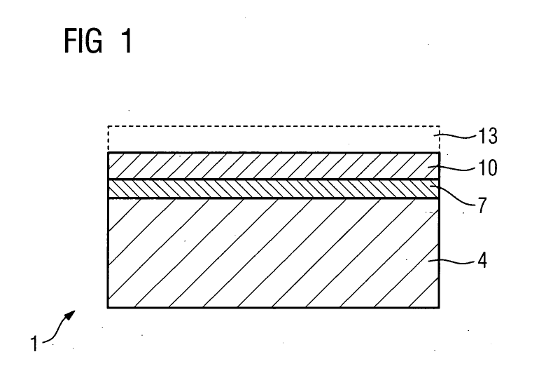

FIG. 1 shows a layer system 1 according to the invention.

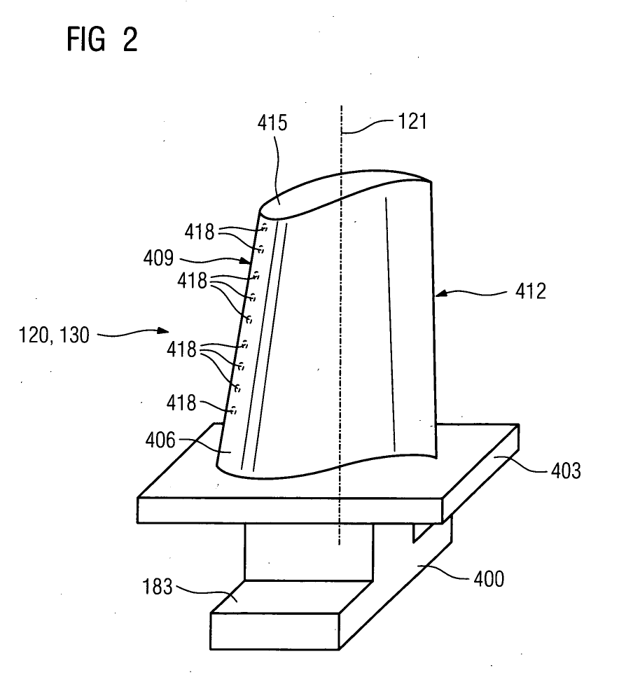

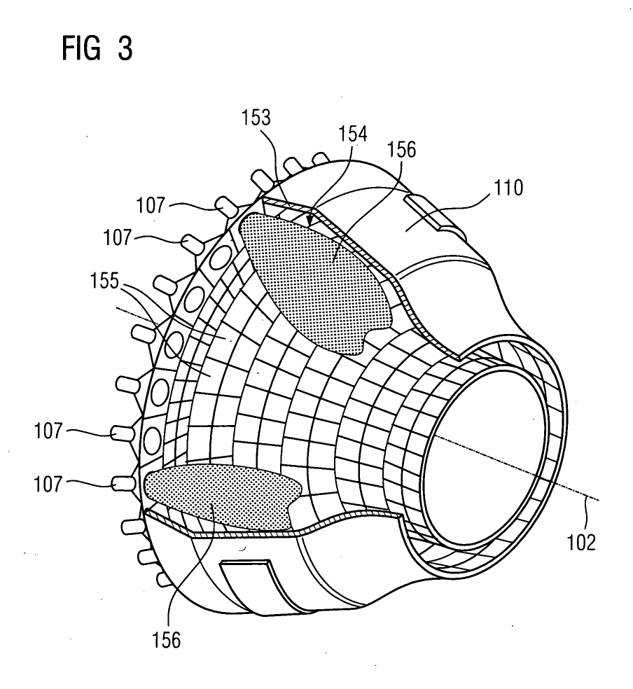

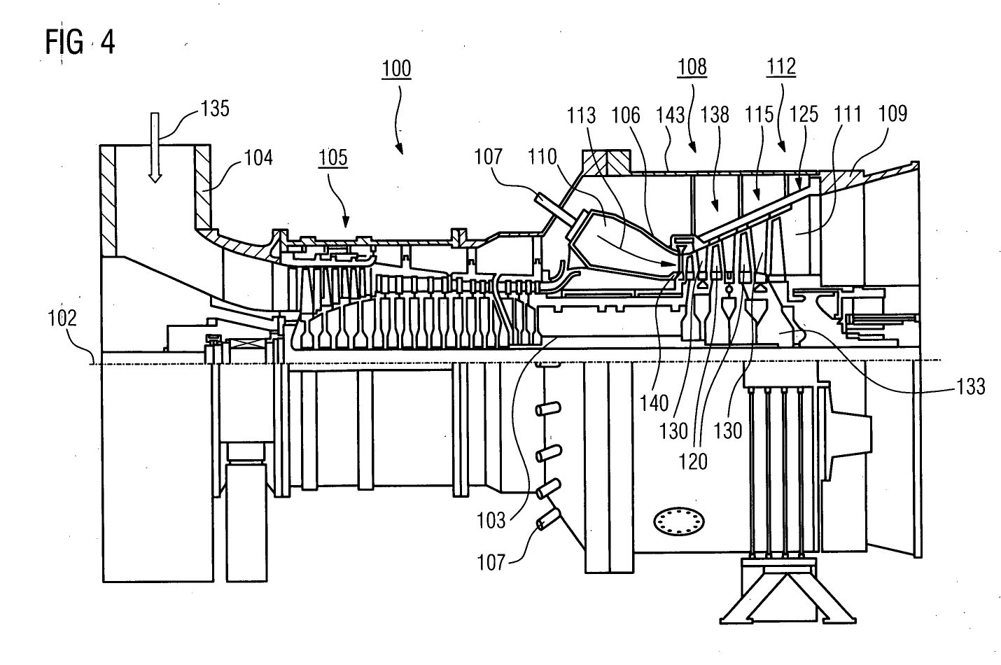

The layer system 1 is, for example, a component of a turbine, such as for example a steam or gas turbine 100 (FIG. 4) for an aircraft or a power plant and is in particular a turbine blade or vane 120, 130 (FIG. 2) or a heat shield element 155 (FIG. 3).

In particular in the case of components for turbines, the substrate 4 consists of a nickel-base, cobalt-base or iron-base superalloy.

At least one protective layer 10, which is in particular of the MCrAlX type, is present on the substrate 4 in a known way.

If appropriate, for applications at particularly high temperatures, a ceramic thermal barrier coating 13 (indicated by dashed lines) may also be present on this protective layer 10, in which case the protective layer 10 constitutes not only a layer protecting against oxidation and/or corrosion but also a bond coat for bonding the ceramic thermal barrier coating 13 to the substrate 4.

According to the invention, between the protective layer 10 and the substrate 4 there is a blocking layer 7, which at least partially includes an intermetallic phase selected from the group consisting of PdAl₂, Ta₂Al, NbAl₂ or Nb₃Al. These intermetallic phases prevent diffusion of aluminum out of the protective layer 10 into the substrate 4.

Intermetallic alloys (phases) have a crystal structure which has completely different properties than the two or more alloy components, and crystallize in a specific type of lattice which does not correspond to the structures of the metals involved. These intermetallic phases may be of stoichiometric composition but may equally form solid solution regions and have an ordered or unordered distribution. The layers of platinum or palladium which are known from the prior art cited in the introduction are pure metallic layers and are not intermetallic.

In a preferred refinement of the invention, the blocking layer 7 may predominantly comprise an intermetallic phase, i.e. a matrix with one of the intermetallic phases PdAl₂, Ta₂Al, NbAl₂ or Nb₃Al, but it is also possible for a plurality of these phases to be present in a phase mixture. The matrix of the blocking layer 7 may, for example, be nanocrystalline in form.

It is also possible for the intermetallic phases to be present as particles in a different metallic matrix, for example in a superalloy of the substrate 4 or an MCrAlX alloy, in particular in nanocrystalline form, i.e. with grain sizes<500 nm, in particular <300 nm or <100 nm.

To produce the intermetallic blocking layer 7, it is also possible first of all to apply Pd, Ta or Nb to the substrate 4 and then to carry out aluminizing and then to convert the applied material into an intermetallic phase by suitable heat treatments. Another example is a platinum-based intermetallic phase.

The blocking layer 7 is in particular designed to be thin compared to the protective layer 10, i.e. ≦50 μm, in particular ≦5 μm, and is produced, for example, electrolytically and/or using powder particles, in particular nanoparticles, so that the thin layer thicknesses can be achieved and the blocking layer 7 does not just comprise one or a small number of individual layers of particles on a micrometer scale.

A layer 10 of the alloy MCrAlX is, for example, approximately 300 μm thick, and consequently the thickness of the blocking layer 7 is expediently between 1 and 17% of the thickness of the layer 10. This applies in very general terms to the blocking layer 7 and the protective layer 10 above it.

The intermetallic phases have a high melting point, so that they retain their structures at the high temperatures of use and are not dissolved through interdiffusion.

The blocking layer 7, in particular by virtue of the materials or morphology selected, is also superplastic, in particular at high temperatures, which can be achieved for example by means of a nanocrystalline structure (grain sizes).

The plasticity is important in order to ensure that the blocking layer 7 is not susceptible to cracking, which would reduce the mechanical strength or corrosion resistance of the layer system 1.

The blocking layer 7 can be produced in various ways.

By way of example, a slurry is used to produce the blocking layer 7. A slurry comprises powder particles (for example partially or completely nanocrystalline) of the material of the blocking layer 7, a carrier agent (for example water, alcohol) and optionally a binder (for example resin).

This slurry can be brushed or sprayed onto the surface of the substrate 4. As it dries, the carrier agent is released and the binder is burnt out if necessary. Then, a compacting and bonding heat treatment is carried out.

It is also possible for the blocking layer 7 to be applied by an electrolytic process, in which, for example, powder particles (partially or completely nanocrystalline) are dispersed in an electrolyte and deposited and/or in which some or all of the elements of the blocking layer 7 are dissolved in the electrolyte and are deposited out of the solution on the substrate 4. In this case too, a subsequent heat treatment can be carried out.

FIG. 2 shows a perspective view of a rotor blade 120 or guide vane 130 of a turbomachine 100 (FIG. 4), which extends along a longitudinal axis 121.

The turbomachine may be a gas turbine of an aircraft or of a power plant 100 for generating electricity, a steam turbine or a compressor.

The blade or vane 120, 130 has, in succession along the longitudinal axis 121, a securing region 400, an adjoining blade or vane platform 403 and a main blade or vane part 406.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade 120, 130.

Superalloys of this type are known, for example, from EP 1 204 776 B1, EP 1 306 454, EP 1 319 729 A1, WO 99/67435 or WO 00/44949; these documents form part of the disclosure. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure.

The blades or vanes 120, 130 may likewise have coatings protecting against corrosion or oxidation (MCrAlX; M is at least one element selected from the group consisting of iron (Fe), cobalt (Co), nickel (Ni), X is an active element and represents yttrium (Y) and/or silicon (Si) and/or at least one rare earth element, or hafnium (Hf)). Alloys of this type are known from EP0486 489 B1, EP0786 017 B1, EP0412 397B1 or EP 1 306 454 A1, which are intended to form part of the present disclosure.

It is also possible for there to be a thermal barrier coating, consisting for example of ZrO₂, Y₂O₄—ZrO₂, i.e. unstabilized, partially stabilized or completely stabilized by yttrium oxide and/or calcium oxide and/or magnesium oxide, to be present on the MCrAlX.

Columnar grains are produced in the thermal barrier coating by means of suitable coating processes, such as for example electron beam physical vapor deposition (EB-PVD).

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

To protect against corrosion, the blade or vane 120, 130 has, for example, suitable, generally metallic coatings (MCrAlX), and to protect against heat, the blade or vane 120, 130 generally also has a ceramic coating.

FIG. 3 shows a combustion chamber 110 of a gas turbine. The combustion chamber 110 is configured, for example, as what is known as an annular combustion chamber, in which a multiplicity of burners 107 arranged circumferentially around the axis of rotation 102 open out into a common combustion chamber space. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 is equipped with a particularly heat-resistant protective layer or is made from material that is able to withstand high temperatures. These may be solid ceramic bricks or alloys with MCrAlX and/or ceramic coatings.

The materials of the combustion chamber wall and their coatings may be similar to the turbine blades or vanes.

A cooling system may also be provided for the heat shield elements 155 and/or their holding elements, on account of the high temperatures in the interior of the combustion chamber 110.

FIG. 4 shows, by way of example, a partial longitudinal section through a gas turbine 100.

In the interior, the gas turbine 100 has a rotor 103 which is mounted such that it can rotate about an axis of rotation 102 and is also referred to as the turbine rotor.

An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses.

To be able to withstand the temperatures which prevail there, they have to be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon and/or at least one rare earth element or hafnium). Alloys of this type are known from EP 0 486 489B1, EP 0 786 017B1, EP 0 412 397 B1 or EP 1 306 454 A1, which are intended to form part of the present disclosure.

A thermal barrier coating, consisting for example of ZrO₂, Y₂O₄—ZrO₂, i.e. unstabilized, partially stabilized or completely stabilized by yttrium oxide and/or calcium oxide and/or magnesium oxide, may also be present on the MCrAlX. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1-18. (canceled)

19. A layer system, comprising:
a substrate;
a protective layer on the substrate;
a thermal barrier coating on the protective layer; and
a blocking layer between the substrate and the protective layer,
wherein the blocking layer is partially formed as an intermetallic phase that is selected from the group consisting of PdAl₂, Ta₂Al, NbAl₂ or Nb₃Al, and the protective layer consists of a MCrAlX alloy.

20. The layer system as claimed in claim 19, wherein the blocking layer comprises an intermetallic phase.

21. The layer system as claimed in claim 19, wherein the blocking layer has a metallic matrix that includes particles of an intermetallic phase.

22. The layer system as claimed in claim 19, wherein the blocking layer includes only one intermetallic phase.

23. The layer system as claimed in claim 19, wherein the blocking layer is formed exclusively from one or more intermetallic phases.

24. The layer system as claimed in claim 19, wherein the blocking layer is designed to be thin compared to the protective layer and is only up to 50 μm thick.

25. The layer system as claimed in claim 24, wherein the blocking layer is less than or equal to 5 μm thick.

26. The layer system as claimed in claim 19, wherein the thickness of the blocking layer is 1-17% of the thickness of the protective layer.

27. The layer system as claimed in claim 19, wherein the blocking layer comprises nanocrystalline particles with intermetallic phase that have grain sizes of less than 500 nm.

28. The layer system as claimed in claim 19, wherein the blocking layer has superplastic properties.

29. The layer system as claimed in claim 19, wherein the substrate is an iron-base, cobalt-base or nickel-base superalloy.

30. The layer system as claimed in claim 19, wherein the layer system is a turbine blade or vane or a heat shield element.

31. A process for producing a layer system, comprising:
providing a substrate;
providing a protective layer on the substrate;
providing a thermal barrier coating on the protective layer;
providing a blocking layer between the substrate and the protective layer and the blocking layer is partially formed as an intermetallic phase that is selected from the group consisting of PdAl₂, Ta₂Al, NbAl₂ or Nb₃Al, and the protective layer consists of a MCrAlX alloy,
wherein a slurry is used to produce the blocking layer.

32. The process as claimed in claim 31, wherein the slurry is brushed onto the substrate.

33. The process as claimed in claim, wherein the slurry is sprayed on.

34. A process for producing a layer system, comprising:
providing a substrate;
providing a protective layer on the substrate;
providing a thermal barrier coating on the protective layer;
providing a blocking layer between the substrate and the protective layer and the blocking layer is partially formed as an intermetallic phase that is selected from the group consisting of PdAl₂, Ta₂Al, NbAl₂ or Nb₃Al, and the protective layer consists of a MCrAlX alloy,
wherein the blocking layer is produced by an electrolytic process.

35. The process as claimed in claim 34, wherein powder particles consisting of a material for the blocking layer dispersed in an electrolyte are deposited.

36. The process as claimed in claim 34, wherein the elements of the blocking layer which are to be deposited are dissolved in an electrolyte.

37. The process as claimed in claim 34, wherein a heat treatment for bonding the blocking layer to the substrate is carried out.
